(19) United States
(12) Patent Application Publication
(10) Pub. No.: US 2009/0316102 A1
(43) Pub. Date: Dec. 24, 2009

(54) LIQUID CRYSTAL DISPLAY

(75) Inventors: Yun-Jung CHO, Asan-si (KR); Seong-Young LEE, Anyang-si (KR); Dong-Gyu KIM, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/477,514

(22) Filed: Jun. 3, 2009

(30) Foreign Application Priority Data
Jun. 19, 2008 (KR) 10-2008-0057798

(51) Int. Cl. G02F 1/1343

(52) U.S. Cl. 349/144; 349/48

(57) ABSTRACT

A liquid crystal display includes; a pair of gate lines including a first gate line and a second gate line, a first data line and a second data line which neighbor each other, each of which is disposed substantially perpendicular to the first gate line and the second gate line, a first thin film transistor connected to the first gate line and the first data line, a second thin film transistor connected to the second gate line and the first data line, the second thin film transistor including a drain electrode, and a pixel electrode including a first subpixel electrode electrically connected to the first thin film transistor and a second subpixel electrode electrically connected to the second thin film transistor, wherein the first subpixel electrode is disposed a horizontal distance apart from the first data line and the second data line such that it does not overlap the first data lien and the second data line as seen from a top plan view, and the second subpixel electrode overlaps both the first data line and the second data line.

This application claims priority to Korean Patent Application No. 10-2008-0057798, filed on Jun. 19, 2008, and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display.

(b) Description of the Related Art

A liquid crystal display (“LCD”) is one of the most widely used flat panel displays (“FPD”), and it is typically composed of two display panels on which field generating electrodes are formed, and a liquid crystal layer interposed between the two display panels. A voltage is applied to the field generating electrodes to generate an electric field within the liquid crystal layer, and the orientation of liquid crystal (“LC”) molecules of the liquid crystal layer is determined to control the polarization of incident light through the generated electric field to display an image. In order to display an image, the LCD may include a plurality of pixels, each of which may individually control the polarization of light incident thereon. Each of the individual pixels may control the polarization of incident light in a discrete interval hereafter referred to as a gray.

Among the LCDs, a vertical alignment (“VA”) mode LCD, which aligns LC molecules such that the long axes of the LC molecules are perpendicular to the display panels in the absence of an electric field, is becoming increasingly popular because of its high contrast ratio and wide reference viewing angle. Here, a reference viewing angle may be defined as a viewing angle that makes the contrast ratio of the display equal to 1:10, or as a limit angle for inversion in luminance between grays.

The wide viewing angle of the VA mode LCD can be realized by cutouts in the field-generating electrodes and protrusions on the field-generating electrodes. Since the cutouts and protrusions can determine the tilt directions of the LC molecules, the tilt directions can be distributed in several directions by using the cutouts and protrusions such that the reference viewing angle is widened.

In a VA mode LCD, the cutouts or the protrusions are formed in or on field generating electrodes to obtain the uniform viewing angle in up, down, right, and left directions, thereby controlling the alignment directions of the LC molecules. However, the cutouts or protrusions formed in or on the field generating electrodes reduce the aperture ratio of the pixel. In order to increase the aperture ratio, the field generating electrodes, e.g., pixel electrodes, may then be formed to overlap signal lines which provide voltages to the pixel electrodes. However, when the pixel electrodes overlap the signal lines, parasitic capacitances generated between the signal lines and the pixel electrodes are increased such that the screen display quality may be deteriorated by crosstalk.

On the other hand, a technique in which one pixel electrode is divided into two subpixel electrodes and high and low voltages are respectively applied to the subpixel electrodes to form the different alignment directions of the LC molecules corresponding to the two subpixel electrodes, thereby improving visibility in right and left viewing angle directions, has been developed.

### BRIEF SUMMARY OF THE INVENTION

The present invention provides a multi-domain liquid crystal display (“LCD”) which prevents crosstalk deterioration due to increasing parasitic capacitance between the signal line and the pixel electrode, as well as providing a high aperture ratio and excellent side visibility.

An exemplary embodiment of an LCD according to the present invention includes; a pair of gate lines including a first gate line and a second gate line, a first data line and a second data line which neighbor each other, each of which is disposed substantially perpendicular to the first gate line, a first thin film transistor connected to the first gate line and the first data line, the first thin film transistor including a first source electrode, a second thin film transistor connected to the second gate line and the first data line, the second thin film transistor including a second source electrode, and a pixel electrode including a first subpixel electrode electrically connected to the first thin film transistor and a second subpixel electrode electrically connected to the second thin film transistor, wherein the first subpixel electrode is disposed a horizontal distance apart from the first data line and the second data line such that it does not overlap the first data line and the second data line as seen from a top plan view, and the second subpixel electrode overlaps both the first data line and the second data line.

In one exemplary embodiment, a ratio of the overlapping area between the second subpixel electrode and the second data line and an overlapping area between the second subpixel electrode and the first data line and the drain electrode may be in the range of about 0.8:1 to about 1.2:1.

In one exemplary embodiment, the LCD may further include a color filter disposed under the pixel electrode.

In one exemplary embodiment, the first data line and the second data line respectively may include a first portion disposed on a first straight line, a second portion disposed on a second straight line separated from the first straight line and substantially parallel to the first straight line, and a third portion connecting the first portion and the second portion, and the second subpixel electrode may overlap the first portion of the first data line and the second portion of the second data line.

In one exemplary embodiment, the second portion of the second data line and the first subpixel electrode are separated from each other as seen from a top plan view.

In one exemplary embodiment, the first subpixel electrode may be substantially surrounded by the second subpixel electrode.

In one exemplary embodiment, a surface area of the first subpixel electrode may be less than a surface area of the second subpixel electrode.

In one exemplary embodiment, a voltage applied to the first subpixel electrode may be higher than a voltage applied to the second subpixel electrode.

In one exemplary embodiment, at least one of the first subpixel electrode and the second subpixel electrode may have a first cutout.

In one exemplary embodiment, the LCD may further include a common electrode disposed substantially opposite to the pixel electrode, wherein the common electrode may have a second cutout.

In one exemplary embodiment, the LCD may further include a color filter disposed under the pixel electrode.

In one exemplary embodiment, the LCD may further include an organic insulator disposed under the pixel electrode.

In one exemplary embodiment, the thickness of the organic insulator may be more than about 1 μm.

### BRIEF DESCRIPTION OF THE DRAWINGS

The above and other features and advantages of the present invention will become more apparent by describing in detailed example embodiments thereof with reference to the accompanying drawings, wherein:

FIG. 1 is a block diagram of an exemplary embodiment of a liquid crystal display (“LCD”) according to the present invention.

FIG. 2 is an equivalent circuit diagram of an exemplary embodiment of two subpixels in an exemplary embodiment of an LCD according to the present invention.

FIG. 3 is an equivalent circuit diagram of an exemplary embodiment of one pixel in an exemplary embodiment of an LCD according to the present invention.

FIG. 4 is a top plan layout view of an exemplary embodiment of one pixel in an exemplary embodiment of an “LCD” according to the present invention.

FIG. 5 and FIG. 6 are cross-sectional views of the exemplary embodiment of an LCD shown in FIG. 4 taken along lines V-V and VI-VI, respectively.

FIG. 7 is a cross-sectional view of an exemplary embodiment of one pixel in another exemplary embodiment of an “LCD” according to the present invention taken along the line V-V of FIG. 4.

FIG. 8 is a graph showing differences per region of an experimental example of an LCD according to the present invention.

FIG. 9 is a graph showing crosstalk of an experimental LCD according to the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Now, a liquid crystal display according to the present invention will be described with reference to drawings.

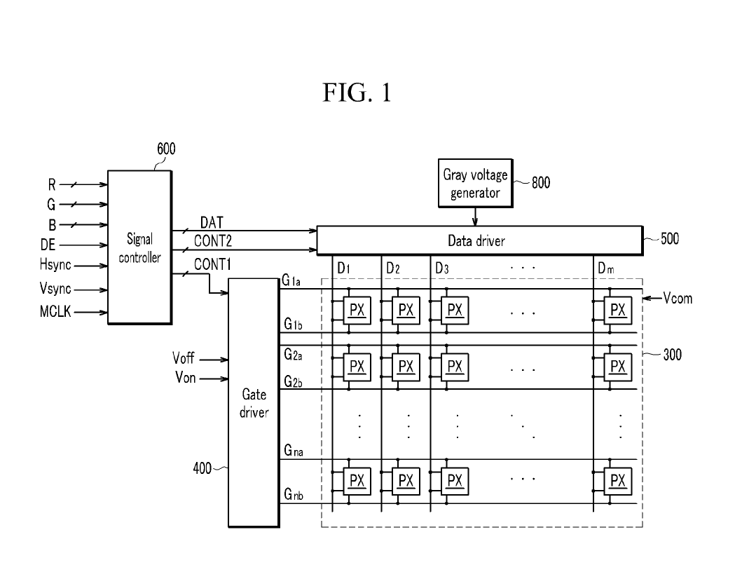

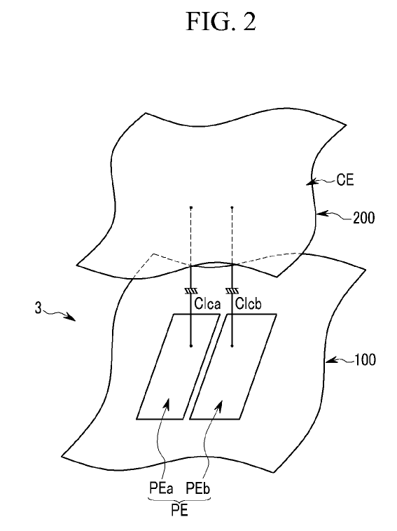

FIG. 1 is a block diagram of an exemplary embodiment of a liquid crystal display (“LCD”) according to the present invention, and FIG. 2 is an equivalent circuit diagram of an exemplary embodiment of two subpixels in a LCD according to the present invention.

As shown in FIG. 1, an exemplary embodiment of an LCD according to the present invention includes a liquid crystal panel assembly 300, a gate driver 400, a data driver 500, a gray voltage generator 800 connected to the data driver 500, and a signal controller 600 for controlling the above elements.

As shown in FIG. 1, the exemplary embodiment of a liquid crystal panel assembly 300 includes a plurality of signal lines G₁ₐ-G_{nb} and D₁-Dₘ, and a plurality of pixels PX that are connected to the plurality of signal lines and disposed in a matrix form. Meanwhile, as shown in FIG. 2, the liquid crystal panel assembly 300 includes lower and upper panels 100 and 200, respectively, that face each other, and a liquid crystal layer 3 that is interposed between the panels 100 and 200.

The signal lines G₁ₐ-G_{nb} and D₁-Dₘ include a plurality of gate lines G₁ₐ-G_{nb} that transmit gate signals (also referred to as “scanning signals”), and a plurality of data lines D₁-Dₘ that transmit data signals. The gate lines G₁ₐ-G_{nb} substantially extend in a row direction to be substantially parallel to each other, and the data lines D₁-Dₘ extend in a column direction to be substantially parallel to each other.

Each pixel PX includes a pair of subpixels PEa and PEb. Each of the subpixels PEa and PEb respectively is electrically connected to a switching element (not shown in FIGS. 1 and 2) connected to the signal lines G₁ₐ-G_{nb} and D₁-Dₘ, and a liquid crystal capacitor CLc, which may be further subdivided into liquid crystal capacitors Clca and Clcb, and a storage capacitor Cst connected thereto. Alternative exemplary embodiments include configurations wherein the storage capacitor Cst may be omitted.

Exemplary embodiments include configurations wherein the switching element is a three terminal element such as a thin film transistor provided on the lower panel 100, a control terminal thereof is connected to the gate line GL, an input terminal thereof is connected to the data line DL, and an output terminal thereof is connected to one of the liquid crystal capacitors Clca/Clcb.

The liquid crystal capacitors Clca/Clcb are connected to the two terminals of subpixel electrodes PEa/Peb, respectively, of the lower panel 100 and a common electrode CE of the upper panel 200, and the liquid crystal layer 3 disposed between the two subpixel electrodes PEa/PEb and CE serves as a dielectric material. The pair of subpixel electrodes PEa and PEb are separated from each other and form a single pixel electrode PE. In the present exemplary embodiment, the common electrode CE is formed on the whole surface of the upper panel 200 and receives the common voltage Vcom. Also in the present exemplary embodiment, the liquid crystal layer 3 has negative dielectric anisotropy. The liquid crystal molecules of the liquid crystal layer 3 may be arranged such that a longitudinal axis of the liquid crystal molecules is substantially perpendicular to the surfaces of the two panels when an electric field is not applied to the field generating electrodes, namely the common electrode CE and the pixel electrode PE.

The storage capacitor Cst functions as an auxiliary capacitor for the liquid crystal capacitor Clc. The storage capacitor Cst includes a pixel electrode 191 and a separate signal line (not shown), which is provided on the lower panel 100 and overlaps the pixel electrode 191 with an insulator disposed therebetween, and the separate signal line is applied with a predetermined voltage such as a common voltage Vcom. Alternative exemplary embodiments include configurations wherein the storage capacitor Cst may include the pixel electrode PE and a previous gate line, which overlaps the pixel electrode PE via an insulator.

In the exemplary embodiment wherein the display panel 300 is configured for color display, each pixel PX uniquely represents one of three primary colors (e.g., the display may display a variety of different colors using spatial division) or each pixel PX sequentially represents the three primary colors in turn (e.g., the display may display a variety of different colors using temporal division), such a that spatial or temporal sum of the primary colors is recognized as a desired color. An exemplary embodiment of a set of the three primary colors includes red, green, and blue colors. Although not shown, exemplary embodiments include configurations wherein the color filter may be disposed on or under the subpixel electrodes PEa and PEb of the lower panel 100, and alternative exemplary embodiments include configurations wherein the color filter may be formed under the common electrode CE of the upper panel 200.

At least one polarizer (not shown) is attached on the outer side of the liquid crystal panel assembly 300, and, when two polarizers are present, the polarization axis of two polarizers may be crossed. In a reflective LCD, one of the two polarizers may be omitted. In the case of the crossed polarization axis polarizers, the light incident to the liquid crystal layer 3 is blocked in the absence of the application of the electric field.

Referring again to FIG. 1, the gray voltage generator 800 generates a plurality of gray voltages (or reference gray voltages) related to transmittance of the pixels PX. In one exemplary embodiment, the (reference) gray voltages may include one set having a positive value for a common voltage Vcom, and another set having a negative value.

The gate driver 400 is connected to the gate lines of the liquid crystal panel assembly 300, and applies gate signals Vg to the gate lines. The gate signals Vg include gate-on voltages Von and gate-off voltages Voff.

The data driver 500 is connected to the data lines of the liquid crystal panel assembly 300, and selects the gray voltages from the gray voltage generator 800 to apply them to the data lines as data voltages. However, in the exemplary embodiment wherein the gray voltage generator 800 does not supply a voltage for all grays but supplies only a predetermined number of reference gray voltages, the data driver 500 divides the reference gray voltages to generate the data voltages for the entire range of grays and select the data signals among those divided reference gray voltages.

The signal controller 600 controls the gate driver 400 and data driver 500.

In one exemplary embodiment, each of the drivers 400, 500, 600, and 800 may be installed directly on the liquid crystal panel assembly 300 in the form of at least one integrated circuit chip. Alternative exemplary embodiments include configurations wherein, each of the drivers 400, 500, 600, and 800 may be installed on a flexible printed circuit film (not shown) to be attached to the liquid crystal panel assembly 300 in the form of a tape carrier package (“TCP”) or installed on a separate printed circuit board (not shown).

Next, the structure of the liquid crystal panel assembly will be described in detail with reference to FIGS. 1-6.

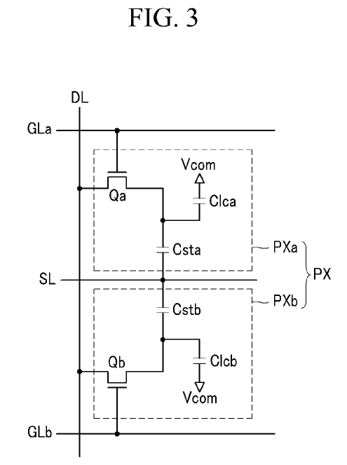

FIG. 3 is an equivalent circuit diagram of an exemplary embodiment of one pixel in an exemplary embodiment of an LCD according to the present invention.

Referring to FIG. 3, the liquid crystal panel assembly according to the present exemplary embodiment includes signal lines including pairs of gate lines GLa and GLb, data lines DL, and storage electrode lines SL, and a plurality of pixels PX that are connected to the signal lines.

Each pixel PX includes a pair of subpixels PXa and PXb. Each subpixel PXa/PXb includes a switching element Qa/Qb connected to the gate line GLa/GLb and the data line DL, a liquid crystal capacitor Clca/Clcb connected to the switching element Qa/Qb, and a storage capacitor Csta/Cstb connected to the switching element Qa/Qb and the storage electrode line SL, respectively.

In the present exemplary embodiment, each switching element Qa/Qb is a three-terminal element formed on the lower panel 100, such as a thin film transistor, which has a control terminal connected to the gate line GLa/GLb, an input terminal connected to the data line DL, and an output terminal connected to the liquid crystal capacitor Clca/Clcb and the storage capacitor Csta/Cstb.

The storage electrode line SL and the pixel electrode PE provided on the lower panel 100 overlap each other with an insulator interposed therebetween to obtain the storage capacitor Csta/Cstb, which supplements the liquid crystal capacitor Clca/Clcb, and a predetermined voltage such as the common voltage Vcom is applied to the storage electrode line SL. However, alternative exemplary embodiments include configurations wherein the subpixel electrode PEa/PEb overlaps a previous gate line with the insulator interposed therebetween to obtain the storage capacitor Csta/Cstb.

Since the explanation of the liquid crystal capacitor Clca/Clcb has already been given above, a duplicate detailed description thereof will be omitted here.

In the exemplary embodiment of an LCD including such a liquid crystal panel assembly, the signal controller 600 may receive input image signals R, G, and B for one pixel PX, convert them into an output image signal DAT for two subpixels PXa and PXb, and transmit the output image signal DAT to the data driver 500. Unlike an exemplary embodiment wherein the pixel is not split into sub-pixels, in the present exemplary embodiment the gray voltage generator 800 makes gray voltage sets for each subpixel PXa and PXb and alternately provide the sets to the data driver 500, or the data driver 500 alternately selects the sets from the gray voltage generator 800, applying different voltages to the two subpixels PXa and PXb. At the time the different gray voltage sets are provided to the data driver 500, the image signals DAT may be corrected so that a combined gamma curve of the two subpixels PXa and PXb gets closer to a reference gamma curve as viewed from a front side of the display. For example, in one exemplary embodiment a combined gamma curve as seen from the front side of the display may be made to accord with the reference gamma curve, and a combined gamma curve as seen from the lateral side may be made to be closer to the reference gamma curve as seen from the front side of the display.

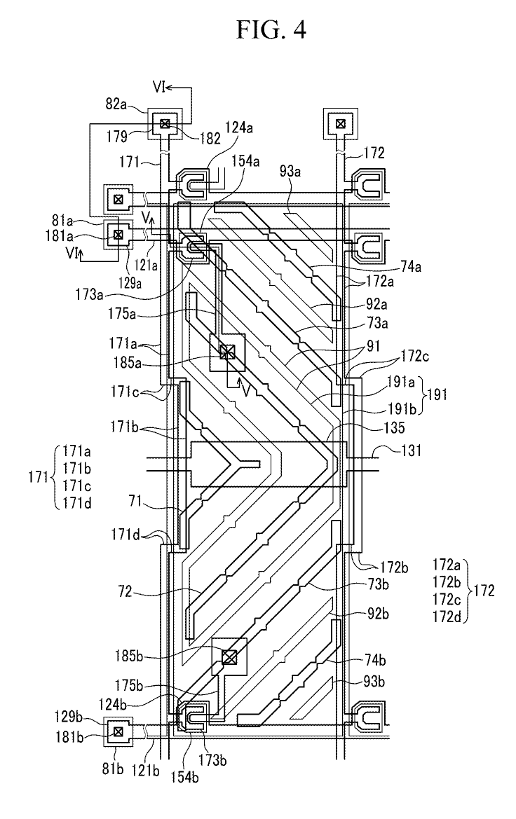

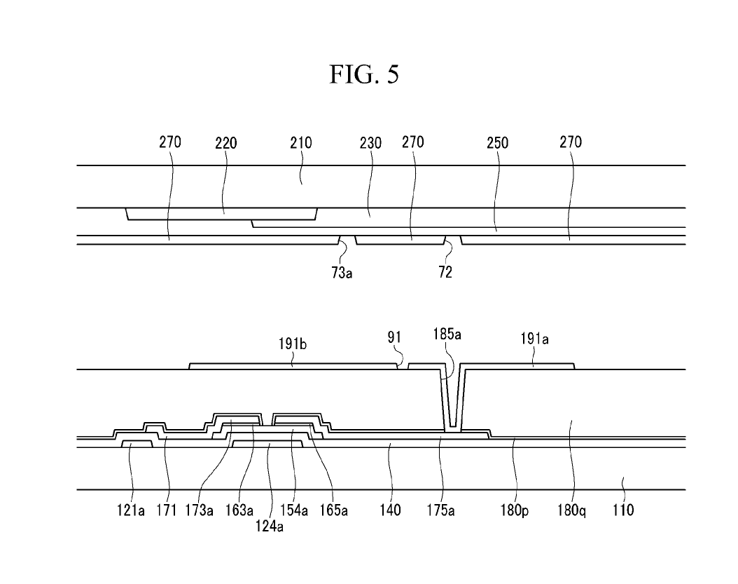

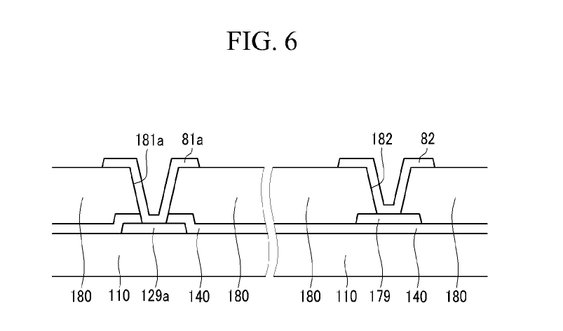

The present exemplary embodiment of the liquid crystal panel assembly according to the present invention will now be described in more detail with reference to FIG. 4 to FIG. 6. FIG. 4 is a top plan layout view of an exemplary embodiment of one pixel in an exemplary embodiment of an LCD according to the present invention, and FIG. 5 and FIG. 6 are cross-sectional views of the exemplary embodiment of an LCD shown in FIG. 4 taken along lines V-V and VI-VI, respectively.

Referring to FIG. 4, FIG. 5, and FIG. 6, the present exemplary embodiment of a liquid crystal panel assembly includes a thin film transistor array panel 100 and a common electrode panel 200 that face each other, and a liquid crystal layer 3 interposed therebetween.

Firstly, the thin film transistor array panel 100 will be described with reference to FIG. 4 to FIG. 6.

A plurality of pairs of first and second gate lines 121a and 121b (only one pair shown), and a plurality of storage electrode lines 131 (only one shown) are formed on an insulation substrate 110. Exemplary embodiments of the insulation substrate 110 may be made of transparent glass, plastic, or other materials having similar characteristics.

The first and second gate lines 121a and 121b transmit gate signals and extend substantially in a transverse direction, and are separated from each other. The first and second gate lines 121a and 121b respectively include a plurality of protruding first and second gate electrodes 124a and 124b, and wide ends 129a and 129b for connecting with another layer or the external driving circuits. Alternative exemplary embodiments include configurations wherein the first and second gate lines 121a and 121b are connected directly to the external driving circuits; in such alternative exemplary embodiments, the wide ends 129a and 129b may be omitted.

The storage electrode lines 131 extend substantially in the transverse direction and include a plurality of protrusions forming a storage electrode 135. The storage electrode lines 131 are applied with a predetermined voltage such as a common voltage Vcom applied to a common electrode 270 of the common electrode panel 200 of the LCD.

In one exemplary embodiment, the gate conductors 121a, 121b, and 131 may be made of an aluminum-containing metal including Al or an Al alloy, a silver-containing metal including Ag or a Ag alloy, a copper-containing metal including Cu or a Cu alloy, a molybdenum-containing metal including Mo or a Mo alloy, chromium (Cr), tantalum (Ta), titanium (Ti), or other materials having similar characteristics. However, exemplary embodiments include configurations wherein the gate lines 121a and 121b and the storage electrode lines 131 may have a multi-layer structure including two conductive layers (not shown) that have differing physical properties. Alternatively, the gate lines 121a and 121b and the storage electrode lines 131 may be made of various other metals or conductors as would be apparent to one of ordinary skill in the art.

A gate insulating layer 140, exemplary embodiments of which may be made of silicon nitride (“SiNx”) or silicon oxide (“SiOx”), is formed on the gate lines 121a and 121b and the storage electrode lines 131.

A plurality of semiconductor islands 154a and 154b, exemplary embodiments of which may be made of hydrogenated amorphous silicon (a-Si) or polysilicon, are formed on the gate insulating layer 140.

A plurality of ohmic contact islands 163a, 165a, 163b, and 165b (163b and 165b are not shown as they are disposed only in the lower thin film transistor as shown in FIG. 4 which is not shown in cross-sectional view) exemplary embodiments of which are made of silicide or n+ hydrogenated amorphous silicon in which an n-type impurity such as phosphorus is highly doped. The ohmic contact islands 163a, 165a, 163b, and 165b form pairs and are disposed on the semiconductor islands 154a and 154b.

A plurality of pairs of data lines 171 and 172, and a plurality of pairs of first and second drain electrodes 175a and 175b are formed on the ohmic contacts 163a, 165a, 163b, and 165b and the gate insulating layer 140.

The data lines 171 and 172 extend substantially in a longitudinal direction thereby being disposed substantially perpendicular to the gate lines 121a and 121b and the storage electrode lines 131, and transmit data voltages. The pair of data lines 171 and 172 are adjacent to each other with a storage electrode 135 interposed therebetween. In the present exemplary embodiment, the data lines 171 and 172 do not extend in a straight line on the whole, but are bent at least twice. In detail, as shown in FIG. 4, the data lines 171 and 172 respectively include first longitudinal portions 171a and 172a extending in the longitudinal direction, first transverse portions 171c and 172c curved from the first longitudinal portions 171a and 172a in the rightward direction and extending in the transverse direction, second longitudinal portions 171b and 172b curved downward from the first transverse portions 171c and 172c and extending in the longitudinal direction, and second transverse portions 171d and 172d curved to the left side from the second longitudinal portions 171b and 172b and extending in the transverse horizontal direction. The first longitudinal portions 171a and 172a and the second longitudinal portions 171b and 172b of two data lines 171 and 172 are disposed in straight lines respectively parallel to each other and separated from each other.

Each data line 171 includes a plurality of the first and second source electrodes 173a and 173b extending toward the gate electrodes 124a and 124b, respectively, and an end portion 179 having a wide width for connecting with another layer or the external driving circuits. Alternative exemplary embodiments include configurations wherein the data lines 171 are connected directly to the external driving circuits; in such alternative exemplary embodiments, the wide ends 179 may be omitted.

The drain electrodes 175a and 175b are separated form the data lines 171 and are opposite to the source electrodes 173a and 173b with respect to the gate electrodes 124a and 124b.

In the present exemplary embodiment, each of the first and second drain electrodes 175a and 175b includes one end portion having a wide area, and the other end portion has a bar shape. The wide end portions are connected to subpixel electrodes 191a and 191b through contact holes 185a and 185b, and portions of the bar end portions are enclosed by the source electrodes 173a and 173b that are curved with a “C” shape having prongs disposed on either side of the drain electrodes.

The first/second gate electrodes 124a/124b, the first/second source electrodes 173a/173b, and the first/second drain electrodes 175a/175b form the first/second thin film transistors (“TFT”) Qa/Qb along with the semiconductor islands 154a/154b, and the channel of the thin film transistors Qa/Qb are formed in the semiconductor islands 154a/154b between the first/second source electrodes 173a/173b and the first/second drain electrodes 175a/175b.

In one exemplary embodiment, the data lines 171 and 172 and the drain electrodes 175a and 175b are made of a refractory metal, exemplary embodiments of which include molybdenum, chromium, tantalum, and titanium, or alloys thereof, and in some exemplary embodiments may have a multilayered structure including the refractory metal layer (not shown) and a conductive layer (not shown) having low resistance. However, the data lines 171 and 172 and the drain electrodes 175a and 175b may alternatively be made of various other metals or conductors as would be apparent to one of ordinary skill in the art.

The ohmic contacts 163a, 165a, 163b, and 165b are interposed only between the underlying semiconductor islands 154a and 154b and the overlying data lines 171 and the drain electrodes 175a and 175b thereon, and reduce contact resistance therebetween.

A passivation layer 180 is formed on the data lines 171 and 172 and the drain electrodes 175a and 175b, and the exposed semiconductor islands 154a and 154b. In one exemplary embodiment, the passivation layer 180 includes a lower layer 180p, exemplary embodiments of which include an inorganic insulator such as silicon nitride or silicon oxide, and an upper layer 180q, exemplary embodiments of which include an organic insulator. In one exemplary embodiment, the organic insulator has a dielectric constant less than 4.0, and may have photosensitivity and provide a flat surface. Alternative exemplary embodiments also include configurations wherein the passivation layer 180 may have a single-layered structure including only the inorganic insulator or the organic insulator.

The upper layer 180q of the passivation layer 180 reduces the coupling effect between the pixel electrodes 191, and the data lines 171 and 172, and, in one exemplary embodiment, has a thickness of more than about 1.0 μm for providing the flat surface of the substrate.

The passivation layer 180 has a plurality of contact holes 182, 185a, and 185b respectively exposing the end portions 179 of the data line 171, and the first and second drain electrodes 175a and 175b, and the passivation layer 180 and the gate insulating layer 140 have a plurality of contact holes 181a and 181b respectively exposing the end portions 129a and 129b of the gate lines 121a and 121b.

A plurality of pixel electrodes 191 including the first and second subpixel electrodes 191a and 191b and a plurality of contact assistants 81a, 81b, and 82 are formed on the passivation layer 180. As discussed above, exemplary embodiments of the pixel electrodes 191 may be made of a transparent conductive material such as ITO or IZO, and a reflective conductive material such as aluminum (Al), silver (Ag), or alloys thereof.

The first/second subpixel electrodes 191a/191b are physically and electrically connected to the first/second drain electrodes 175a/175b through the contact holes 185a/185b, and are applied with data voltages from the first/second drain electrodes 175a/175b. Each of the pair of subpixel electrodes 191a and 191b are applied with different data voltages, which are preset for an input image signal, wherein the size of the data voltages may be set depending on the size and shape of the sub-pixel electrodes 191a and 191b. In one exemplary embodiment, the areas of the first and second subpixel electrodes 191a and 191b may be different from each other. In one exemplary embodiment, the first sub-pixel electrode 191a is supplied with a higher voltage than the second sub-pixel electrode 191b, and the area of the first subpixel electrode 191a is smaller than that of the second subpixel electrode 191b.

The subpixel electrodes 191a and 191b applied with the data voltages generate an electric field together with the common electrode 270 to determine the arrangements of the liquid crystal molecules of the liquid crystal layer 3 disposed between the two subpixel electrodes 191a/191b and the common electrode 270.

Each of the subpixel electrodes 191a and 191b, and the common electrode 270 form the first/second liquid crystal capacitors Clca/Clcb to store applied voltages even after the thin film transistors Qa/Qb are turned off. The first subpixel electrode/second subpixel electrode 191a/191b overlap the storage electrode 135 to form the first/second storage capacitor Csta/Cstb, which are connected in parallel with the first/second liquid crystal capacitors Clca/Clcb to enhance the voltage storing capacity thereof.

Both transverse boundaries of the first subpixel electrode 191a are respectively disposed neighboring the first longitudinal portion 171a of the data line 171 that is bent outward with respect to the pixel electrode 191 and the second longitudinal portion 172b of the neighboring data line 172 and are separated from each other by a predetermined interval. That is, when the first subpixel electrode is projected on the same plane as the first data line and the second data line, the projection patterns thereof are separated from each other. Accordingly, the first subpixel electrode 191a does not overlap the data lines 171 and 172, and is separated from the data lines 171 and 172 such that the coupling effect between the first subpixel electrode 191a and the data lines 171 and 172 is reduced, thereby preventing cross talk that can be generated due to coupling between the first subpixel electrode 191a and the data lines 171 and 172.

The second subpixel electrode 191b overlaps the second longitudinal portion 171b of the data line 171, and the first longitudinal portion 172a of the data line 172 neighboring the data line 171. In this way, the second subpixel electrode 191b is widely formed to overlap the portion 171b of the data line 171 and the first longitudinal portion 172a of the data line 172, thereby increasing the aperture ratio of the LCD. In one exemplary embodiment, the ratio of the overlapping area between the second subpixel electrode 191b, and the data line 171 and the drain electrode 175b, and the overlapping area between the second subpixel electrode 191b and the first longitudinal portion 172a of the data line 172, is in the range of about 0.8:1 to about 1.2:1. As described above, the ratio of the overlapping area between the second subpixel electrode 191b and the data lines 171 and 172 that are disposed neighboring thereto on the right and left sides is controlled such that differences of the parasitic capacitances generated between the second subpixel electrode 191b and the data line 171 and 172 that are disposed neighboring thereto on the right and left sides are decreased, thereby preventing cross talk deterioration that can be generated by a parasitic capacitance deviation between the second subpixel electrode 191b and the neighboring data lines 171 and 172.

In the present exemplary embodiment, a pair of the first and second sub-pixel electrodes 191a and 191b forming one pixel electrode 191 engage with each other with a gap 91 disposed therebetween, and the first sub-pixel electrode 191a is interposed within the second sub-pixel electrode 191b. That is, the second subpixel electrode 191b substantially surrounds the first subpixel electrode 191a, and they are separated by the gap 91 such that they are not overlapped with each other.

The second subpixel electrode 191b has upper cutouts 92a and 93a and lower cutouts 92b and 93b, and the second subpixel electrode 191b is divided into a plurality of regions by the cutouts 92a, 92b, 93a, and 93b. The cutouts 92a, 92b, 93a, and 93b are substantially symmetrical with respect to the storage electrode line 131.

The upper and lower cutouts 92a, 92b, 93a, and 93b obliquely extend from the right edge of the pixel electrode 191 to the left edge, the upper edge, or the lower edge. The upper and lower cutouts 92a, 92b, 93a, and 93b are respectively disposed on the lower-half portion and the upper-half portion of the second subpixel electrode 191b with respect to the storage electrode line 131. The upper and lower cutouts 92a, 92b, 93a, and 93b are inclined with respect to the gate line 121 by an angle of about 45° and the upper cutouts 92a and 93a extend substantially perpendicularly to the lower cutouts 92b and 93b. The upper cutouts 92a and 93a extend substantially parallel to one another, and the lower cutouts 92b and 93b extend substantially parallel to one another.

Accordingly, the lower-half portion of the pixel electrode 191 is divided into four regions by the gaps 91 and the lower cutouts 92b and 93b, and the upper-half portion thereof is divided into four regions by the gaps 91 and the upper cutouts 92a and 93a. Here, the number of regions or cutouts may vary depending on design components, such as the size of the pixel electrode 191, the length ratio of the horizontal side and the vertical side of the pixel electrode 191, the type of liquid crystal layer 3, or other characteristics.

In the present exemplary embodiment, the oblique portions of the cutouts 92a, 92b, 93a, and 93b include notches having a triangular shape. Alternative exemplary embodiments include configurations wherein the notches may have a quadrangular, a trapezoidal, or a semicircular shape, and may be convex or concave. These cutouts 92a, 92b, 93a, and 93b determine the arrangement direction of the liquid crystal molecules 3 disposed on the corresponding regions.

The contact assistants 81a, 81b, and 82 are respectively connected to the end portions 129a and 129b, and 179, of the gate lines 121a and 121b, and the data lines 171, through the contact holes 181a, 181b, and 182. The contact assistants 81a, 81b, and 82 complement adhesion of the end portions 129a and 129b, and 179, of the gate lines 121a and 121b, and the data line 171, with external devices, and protect them from abrasion and other manufacturing induced defects.

Next, the common electrode panel 200 will be described with reference to FIG. 4 and FIG. 5.

A light blocking member 220 is formed on an insulating substrate 210. Exemplary embodiments of the insulating substrate 210 may be made of a material such as transparent glass or plastic or other materials having similar characteristics. The light blocking member 220 may also be called a black matrix and prevents light leakage. The light blocking member 220 prevents light leakage between the pixel electrodes 191 and defines opening regions facing the pixel electrodes 191. However, the light blocking member 220 may have a plurality of openings (not shown) facing the pixel electrodes 191 and having substantially the same shape as the pixel electrodes 191.

In the exemplary embodiment wherein the display is a color display, a plurality of color filters 230 is formed on the substrate 210. The color filters 230 are mainly disposed in the openings enclosed by the light blocking member 230, and may extend along the length of the pixel electrodes 191 in the longitudinal direction. In one exemplary embodiment, each color filter 230 may display one of primary colors such as three primary colors of red, green, and blue.

An overcoat 250 is formed on the color filters 230 and the light blocking member 220. In one exemplary embodiment, the overcoat 250 may be made of an insulating material, either organic or inorganic, and it prevents the color filters 230 from being exposed and provides a flat surface. Exemplary embodiments include configurations wherein the overcoat 250 may be omitted.

A common electrode 270 is formed on the overcoat 250. The common electrode 270 is made of a transparent conductor, exemplary embodiments of which include ITO and IZO.

The common electrode 270 includes a set of a plurality of cutouts 71, 72, 73a, 73b, 74a, and 74b.

One set of cutouts 71-74b faces one pixel electrode 191, and includes first and second central cutouts 71 and 72, upper cutouts 73a and 74a, and lower cutouts 73b and 74b. Each of the cutouts 71-74b is individually disposed between the neighboring cutouts 92a-93b of the pixel electrode 191. Also, each of cutouts 71-74b includes at least one oblique branch disposed substantially parallel to the upper cutouts 92a and 93a or the lower cutouts 92b and 93b of the pixel electrode 191.

In the present exemplary embodiment, the upper and lower cutouts 73a-74b respectively include an oblique branch, a transverse branch, and a longitudinal branch. The oblique branch substantially extends from the right edge of the pixel electrode 191 to the left, upper, or lower edge and is substantially parallel to the upper or lower cutouts 92a-93b of the pixel electrode 191. The transverse branch and the longitudinal branch extend from the each end of the oblique branch while overlapping the edge of the pixel electrode 191, and form an obtuse angle with the oblique branch.

The first and second central cutouts 71 include a central transverse branch, a pair of oblique branches, and a pair of end longitudinal branches. The central transverse branch extends approximately from the right edge of the pixel electrode 191 to the left side according to the transverse central line of the pixel electrode 191, and a pair of oblique branches extend from the central transverse branch toward the left edge of the pixel electrode 191 and approximately parallel to the upper and lower cutouts 73a, 73b, 74a, and 74b. In one exemplary embodiment, the central transverse branch of the second central cutout may be relatively short. The end longitudinal branches extend from each end of the oblique branches while overlapping the left edge of the pixel electrode 191 and form an obtuse angle with the oblique branch.

In the present exemplary embodiment, the oblique portions of the cutouts 71-74b include notches with a triangular shape. Similar to the notches in the cutouts 92-93b in the pixel electrodes 191, alternative exemplary embodiments include configurations wherein the notches in the cutouts 71-74b may have a quadrangular, a trapezoidal, or a semicircular shape.

The number and direction of the cutouts 71-74b may be changed according to design elements.

Alignment layers (not shown) may be applied on inner surfaces of the display panels 100 and 200, and in one exemplary embodiment may be homeotropic alignment layers.

Polarizers (not shown) may be attached on outside surfaces of the display panels 100 and 200 display panel 100 and 200, and in one exemplary embodiment the transmissive axis of two polarizers are disposed substantially perpendicular to each other, and also disposed so that one transmissive axis thereof is substantially parallel to the gate line 121.

The LCD may include a backlight unit (not shown) for providing light to the polarizers, the display panels 100 and 200, and the liquid crystal layer 3.

In the present exemplary embodiment, the liquid crystal layer 3 has negative dielectric anisotropy, and may be oriented such that the major axes of the liquid crystal molecules of the liquid crystal layer 3 are substantially perpendicular to the surfaces of the two display panels 100 and 200 when no electric field is applied. Accordingly, the incident light is blocked by the crossed polarizers.

If the common electrode 270 is applied with the common voltage and the pixel electrode 191 is applied with the data voltage, an electric field substantially perpendicular to the surface of the display panels 100 and 200 is formed. Thus, liquid crystal molecules of the liquid crystal layer 3 change directions so that the major axes thereof become substantially perpendicular to the direction of the electric field in response to the electric field. Hereinafter, both the pixel electrode 191 and the common electrode 270 are commonly referred to as “field generating electrodes”.

On the other hand, the cutouts 92a, 92b, 93a, and 93b of the pixel electrode and the cutouts 71-74b of the common electrode, and the oblique edges of the pixel electrode 191 disposed substantially parallel to them, distort the electric field to have a horizontal component, which determines the tilt directions of the liquid crystal molecules. The horizontal component of the main electric field is disposed substantially perpendicular to the oblique edges of the cutouts 92a-93b and 71-74b, and the oblique edges of the pixel electrodes 191.

One cutout set 71-74b of the common electrode and one cutout set 92a-93b of the pixel electrode divide the pixel electrode 191 into a plurality of subregions, and each of the subregions has two major edges forming the oblique angle with the main edges of the pixel electrode 191. Since the liquid crystal molecules on each subregion tilt substantially perpendicular to the major edges, the azimuthal distribution of the tilt directions is localized to four directions. In this way, the reference viewing angle of the LCD is increased by increasing the variation in the tilt directions of the liquid crystal molecules in a single pixel.

Alternative exemplary embodiments include configurations wherein at least one cutout 92a-93b and 71-74b can be replaced with a protrusion or a depression, and the shape and disposition of the cutouts 92a-93b and 71-74b can be modified.

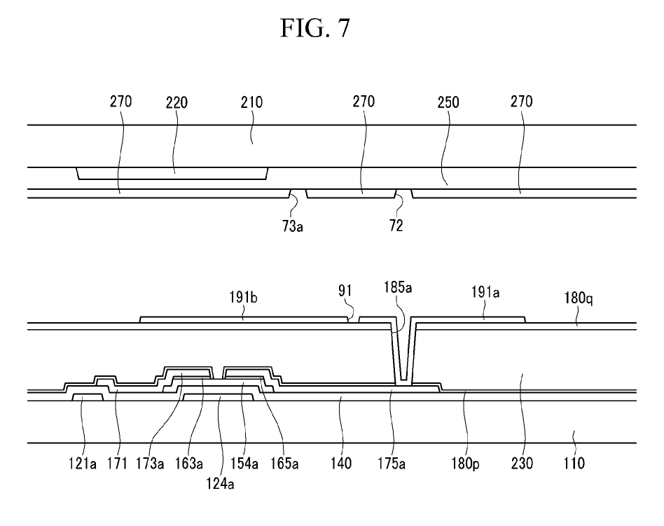

Now, another exemplary embodiment of an LCD according to the present invention will be described with reference to FIG. 7 as well as FIG. 4. FIG. 7 is a cross-sectional view of another exemplary embodiment of an LCD according to the present invention.

A layered structure of the present exemplary embodiment of a liquid crystal panel assembly is substantially similar to the layered structure of the liquid crystal panel assembly shown in FIG. 4 to FIG. 6.

Referring to a TFT array panel, a plurality of gate conductors including a plurality of pairs of gate lines 121a and 121b and a plurality of storage electrode lines 131 are formed on an insulating substrate 110. Each of the gate lines 121a and 121b includes a plurality of first and second gate electrodes 124a and 124b and an end portion 129a and 129b, and each of storage electrode lines 131 includes a plurality of storage electrodes 135. A gate insulating layer 140 is formed on the gate conductors 121a, 121b, and 131. A plurality of first and second semiconductor islands 154a and 154b are formed on the gate insulating layer, and a plurality of ohmic contacts 163a and 165a are formed thereon. A data conductor including a plurality of data lines 171 and 172, and a plurality of first and second drain electrodes 175a and 175b, are formed on the ohmic contacts and the gate insulating layer. The data lines 171 include a plurality of first and second source electrodes 173a and 173b and end portions 179a and 179b. As shown in FIG. 4, each of the data lines 171 and 172 includes the first longitudinal portions 171a and 172a extending in the longitudinal direction, the first transverse portions 171c and 172c curved from the first longitudinal portions 171a and 172a in the rightward direction and extending in the transverse direction, the second longitudinal portions 171b and 172b curved downward from the first transverse 171c and 172c and extending in the longitudinal direction, and the second transverse portions 171d and 172d curved in the left side from the second longitudinal portions 171b and 172b and extending in the transverse horizontal direction. The first longitudinal portions 171a and 172a and the second longitudinal portions 171b and 172b of two data lines 171 and 172 are disposed on straight lines respectively substantially parallel to each other and separated from each other.

A passivation layer 180 is formed on the data conductors 171, 172, 175a, and 175b and the exposed semiconductor islands 154a and 154b, and a plurality of first and second subpixel electrodes 191a and 191b, and a plurality of contact assistants 81a, 81b, and 82 are formed on the passivation layer 180.

However, in the present exemplary embodiment of an LCD shown in FIG. 7, a color filter 230 is formed on a lower passivation layer 180p, differently from the previous exemplary embodiment of an LCD of FIG. 4 to FIG. 6. The passivation layer 180p may prevent the pigment of the color filter 230 from inflowing into the exposed semiconductor islands 154a and 154b. Exemplary embodiments include configurations wherein the color filter 230 may be formed by a photo process or Inkjet printing. An upper passivation layer 180q is formed on the color filter and the lower passivation layer 180p. In one exemplary embodiment, the upper passivation layer 180q may be made of an organic material having photosensitivity. Also, the upper passivation layer 180q reduces the coupling effect between the pixel electrode 191 and the data lines 171a and 171b, and in one exemplary embodiment, the thickness thereof is more than about 1.0 μm in order to provide a flat surface on which the pixel electrodes 191 may be disposed.

Referring to the common electrode panel 200, a light blocking member 220, an overcoat 250, and a common electrode 270 are formed on an insulating substrate 210. However, alternative exemplary embodiments also include configurations wherein the light blocking member 220 may be formed in the TFT array panel having the color filter 230, and when the color filter 230 is formed by Inkjet printing, the light blocking member 220 may function as a partition defining a region where the ink is filled.

In the present exemplary embodiment of an LCD of FIG. 7, similar to the exemplary embodiment of an LCD of FIG. 4 to FIG. 6, the transverse boundaries of the first subpixel electrode 191a are respectively disposed neighboring the first longitudinal portion 171a of the data line 171 that is bent outward with respect to the pixel electrode 191 and the second longitudinal portion 172b of the neighboring data line 172, and are separated from each other by a predetermined interval. That is, when the first subpixel electrode is projected on the same plane as the first data line and the second data line, the projection patterns thereof are separated from each other. Accordingly, the first subpixel electrode 191a does not overlap the data lines 171 and 172, and is separated from the data lines 171 and 172 such that the coupling effect between the first subpixel electrode 191a and the data lines 171 and 172 is reduced, thereby preventing cross talk that can be generated due to coupling between the first subpixel electrode 191a and the data lines 171 and 172.

The second subpixel electrode 191b overlaps the portion 171b of the data line 171, and the portion 172a of the data line 172 neighboring the data line 171. In this way, the second subpixel electrode 191b is widely formed to overlap the portion 171b of the data line 171 and the portion 172a of the data line 172, thereby increasing the aperture ratio of the LCD. In one exemplary embodiment, the ratio of the overlapping area between the second subpixel electrode 191b, and the data line 171 and the drain electrode 175b, and the overlapping area between the second subpixel electrode 191b and the portion 172a of the data line 172, is in the range of about 0.8:1 to about 1.2:1. As described above, the ratio of the overlapping area between the second subpixel electrode 191b and the data lines 171 and 172 that are disposed neighboring it on the right and left sides is controlled such that the differences of the parasitic capacitances generated between the second subpixel electrode 191b and the data lines 171 and 172 that are disposed neighboring it on the right and left sides are decreased, thereby preventing cross talk deterioration that can be generated by parasitic capacitance deviation between the second subpixel electrode 191b and the neighboring data lines 171 and 172.

The operation of the LCD will now be described in detail.

Again referring to FIG. 1, the signal controller 600 receives input image signals R, G, and B and input control signals, exemplary embodiments of which include a vertical synchronization signal Vsync, a horizontal synchronizing signal Hsync, a main clock signal MCLK, and a data enable signal DE for controlling display of the input image signals from an external graphics controller (not shown). The signal controller 600 appropriately processes the input image signals R, G, and B based on the input control signals according to the operational conditions of the liquid crystal panel assembly 300, and generates a gate control signal CONT1 and a data control signal CONT2. Then, the signal controller 600 transmits the gate control signal CONT1 to the gate driver 400, and transmits the data control signal CONT2 and the processed image signal DAT to the data driver 500.

In the present exemplary embodiment, the gate control signal CONT1 includes a scanning start signal STV for instructing the gate driver 400 to start scanning, at least one clock signal CPV for controlling an output cycle of the gate-on voltage Von, and an output enable signal OE for defining a width of the gate-on voltage Von.

In the present exemplary embodiment, the data control signal CONT2 includes a horizontal synchronization start signal STH for informing the data driver 500 of the start of transmission of the data for one row of the subpixels PXa and PXb, a load signal LOAD for instructing to apply analog data voltages to the data lines D1 to D2m, and a data clock signal HCLK. Exemplary embodiments include configurations wherein the data control signal CONT2 may further include an inversion signal RVS for inverting the voltage polarity of the analog data voltage with respect to the common voltage Vcom (hereinafter, “the polarity of the data voltage with respect to the common voltage” is simply referred to as “the polarity of the data voltage”).

The data driver 500 sequentially receives image data DAT for the subpixels PXa and PXb of one row according to the data control signal CONT2 from the signal controller 600, shifts the data, and selects a gray voltage corresponding to the image data DAT among the gray voltages from the gray voltage generator 800. Then, the image data DAT is converted into the corresponding data voltage and is applied to the corresponding one of the data lines D1 to D2m.

The gate driver 400 sequentially applies the gate-on voltage Von to the gate lines G1 to Gn according to the gate control signal CONT1 from the signal controller 600 so as to turn on the switching elements Qa and Qb connected to the gate lines G1 to Gn. Then, the data voltage that is applied to the data lines D1 to D2m is applied to the corresponding subpixels PXa and PXb through the turned-on switching elements Qa and Qb.

A difference between the data voltages that are applied to the subpixels PXa and PXb and the common voltage Vcom corresponds to a charging voltage of the liquid crystal capacitor Clca and Clcb, that is, a pixel voltage. The alignment of liquid crystal molecules varies depending on the size of the pixel voltages in each of the subpixels, that is, a subpixel voltage, and the polarization of light is changed depending on the alignment of the liquid crystal molecules when light passes through the liquid crystal layer 3. The change in polarization causes a change in transmittance of light due to the polarizer.

One input image data, e.g., one of the input image signals R, G or B corresponding to a single data line, is converted into a pair of output image data, and the pair of output image data result in different transmittances of the subpixels PXa and PXb respectively including a pair of subpixel electrodes 191a and 191b. Accordingly, different gamma curves appear in the two subpixels, and the gamma curve of one pixel PX including the subpixels Pxa and PXb is a curved line in which the gamma curves are combined. In one exemplary embodiment a combined gamma curve as seen from a front side having a viewing angle substantially perpendicular to the display panel 300 is selected to match a reference gamma curve that is the most suitable for the liquid crystal panel assembly, and a combined gamma curve as seen from a lateral side of the display is selected to be closer to the reference gamma curve as seen from the front side. Accordingly, the image data is converted to thereby improve the side visibility. Furthermore, as above-described, in one exemplary embodiment, the area of the first subpixel electrode 191a receiving the relatively higher voltage is smaller than the area of the second subpixel electrode 191a such that distortion of the combined gamma curve in the lateral side may be minimized.

The data driver 500 and the gate driver 400 repeat the same operation for every one horizontal period, which is also called “1H” and is equal to one cycle of the horizontal synchronizing signal Hsync. By this method, the gate-on voltage Von is sequentially applied to all the gate lines G1a to Gnb, and the data voltages are applied to all the subpixels PXa and PXb.

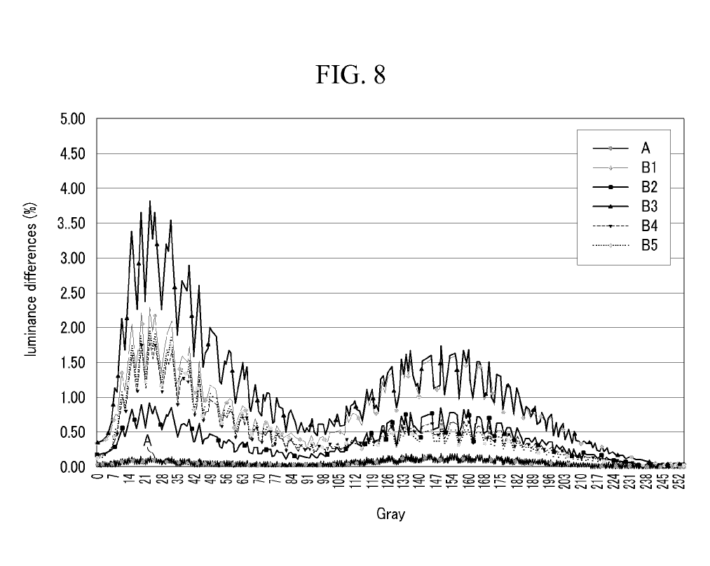

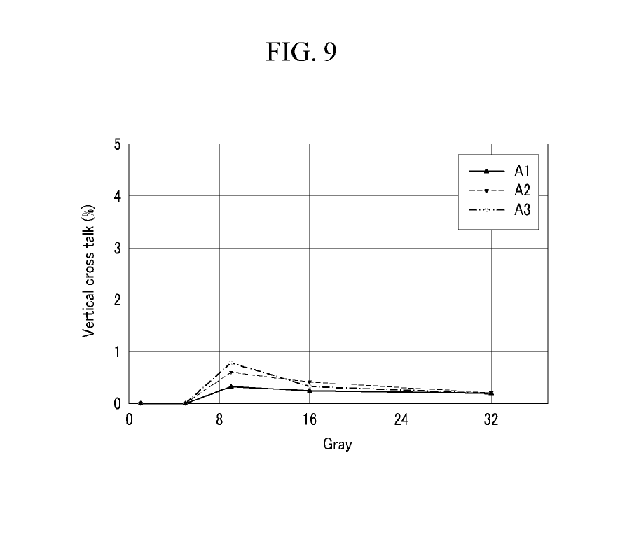

Next, the display characteristics and the crosstalk of an experimental example of an LCD according to the present invention will be described with reference to FIG. 8 and FIG. 9.

FIG. 8 is a graph showing the differences in luminance across different viewing angles of experimental examples of various LCD configurations and an experimental example of an exemplary embodiment of an LCD according to the present invention, and FIG. 9 is a graph showing a cross talk of an experimental example of an LCD according to the present invention.

Firstly, in the first experimental example of the present invention, a plurality of examples B1, B2, B3, B4, and B5 in which a pixel electrode is divided into the first and second subpixel electrodes, and the first subpixel electrode overlaps the first data line or the second data line, are provided. Also, an example A according to an exemplary embodiment of the present invention in which a pixel electrode is divided into the first and second subpixel electrodes and both subpixel electrodes are driven, substantially simultaneously, the first subpixel electrode does not overlap the data line and is separated from the data line, the second subpixel electrode is widely formed to be overlapped with the data line, and the ratio of the overlapping areas between the second subpixel electrode and two neighboring data lines are controlled in the range of about 0.8:1 to about 1.2:1 is provided. Here, the differences between test pattern regions and the remaining regions per grays among test patterns for the cross talk were measured. In the experimental examples A, B1, B2, B3, B4 and B5, the different conditions are all the same except for the overlapping relations and the shape of the pixel electrodes and the data lines.

Referring to FIG. 8, compared with the cases B1, B2, B3, B4, and B5 in which the pixel electrode is divided into the first and second subpixel electrodes, and the first subpixel electrode overlaps the first data line or the second data line, the luminance differences per across different viewing angles according to all grays are not generated in the example A which has a structure according to an exemplary embodiment of the present invention, e.g., there is little or no luminance variation across different viewing angles for a wide range of grays. That is, the visibility of the LCD is improved in the case A which has a structure according to an exemplary embodiment of the present invention.

Next, the ratios of the cross talk of the lower portion of the LCD were measured under the driving of the LCD in various examples A1, A2, and A3 in which a pixel electrode is divided into the first and second subpixel electrodes and driven, substantially simultaneously. The examples A1, A2 and A3 include configurations wherein the first subpixel electrode does not overlap the data line and is separated from the data line, the second subpixel electrode is widely formed to be overlapped with the data line, and the ratio of the overlapping areas between the second subpixel electrode and two neighboring data lines are controlled in the range of about 0.8:1 to about 1.2:1. In these experimental examples, the ratios of the cross talk were measured on the same positions for the various examples A1, A2, and A3 in which the different conditions are the same, and the size of the pixel or the position of the cutouts of the LCD are changed.

Referring to FIG. 9, in the example of an LCD according to an exemplary embodiment of the present invention, the ratio of the cross talk of the LCD is very low at equal to or less than 1%. Accordingly, in the case of the LCD according to an exemplary embodiment of the present invention, the first subpixel electrode does not overlap the data line and is separated from the data line such that the cross talk of the first subpixel electrode and the data line is reduced, simultaneously, and the overlapping areas between the second subpixel electrode and two neighboring data lines are the same such that the cross talk due to the coupling effect between the second subpixel electrode and two neighboring data lines may be decreased.

According to an exemplary embodiment of the present invention, the pixel electrode is divided into the first and second subpixel electrodes, and the different gamma curves appear in the two subpixels to thereby improve the visibility of the LCD.

Also, the first subpixel electrode does not overlap the data line and is separated from the data line, and the second subpixel electrode overlaps the data line such that the parasitic capacitance between the first subpixel electrode and the data line is remarkably reduced to thereby prevent cross talk deterioration, and simultaneously increase the aperture ratio of the LCD. Furthermore, the ratio of the overlapping area between the second subpixel electrode, and the first data line and the second data line, is controlled in the range of about 0.8:1 to about 1.2:1 such that the difference between the parasitic capacitances generated between the second subpixel electrode and the data lines disposed in the right and the left sides thereof is decreased, and as a result, the cross talk deterioration due to the parasitic capacitance deviation between the second subpixel electrode and the neighboring data line may be prevented.

Accordingly, an LCD having excellent optical characteristics may be provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a pair of gate lines including a first gate line and a second gate line;
a first data line and a second data line which neighbor each other, each of which is disposed substantially perpendicular to the first gate line;
a first thin film transistor connected to the first gate line and the first data line;
a second thin film transistor connected to the second gate line and the first data line, the second thin film transistor including a drain electrode; and
a pixel electrode including a first subpixel electrode electrically connected to the first thin film transistor and a second subpixel electrode electrically connected to the second thin film transistor,
wherein the first subpixel electrode is disposed a horizontal distance apart from the first data line and the second data line such that it does not overlap the first data line and the second data line as seen from a top plan view, and
the second subpixel electrode overlaps both the first data line and the second data line.

2. The liquid crystal display of claim 1, wherein
a ratio of an overlapping area between the second subpixel electrode and the second data line and an overlapping area between the second subpixel electrode and the first data line and the source electrodes, is in a range of about 0.8:1 to about 1.2:1.

3. The liquid crystal display of claim 2, further comprising
a color filter disposed under the pixel electrode.

4. The liquid crystal display of claim 2, wherein
the first data line and the second data line respectively include a first portion disposed on a first straight line, a second portion disposed on a second straight line separated from the first straight line and substantially parallel to the first straight line, and a third portion connecting the first portion and the second portion, and
the second subpixel electrode overlaps the first portion of the first data line and the second portion of the second data line.

5. The liquid crystal display of claim 4, wherein,
the second portion of the second data line and the first subpixel electrode are separated from each other as seen from a top plan view.

6. The liquid crystal display of claim 5, wherein
the first subpixel electrode is substantially surrounded by the second subpixel electrode.

7. The liquid crystal display of claim 6, wherein
a surface area of the first subpixel electrode is less than a surface area of the second subpixel electrode.

8. The liquid crystal display of claim 7, wherein
a voltage applied to the first subpixel electrode is higher than a voltage applied to the second subpixel electrode.

9. The liquid crystal display of claim 2, wherein
at least one of the first subpixel electrode and the second subpixel electrode has a first cutout.

10. The liquid crystal display of claim 9, further comprising
a common electrode disposed substantially opposite to the pixel electrode,
wherein the common electrode has a second cutout.

11. The liquid crystal display of claim 2, wherein
an organic insulator is disposed under the pixel electrode.

12. The liquid crystal display of claim 1, wherein
at least one of the first subpixel electrode and the second subpixel electrode has a first cutout.

13. The liquid crystal display of claim 12, further comprising:
a common electrode is disposed substantially opposite to the pixel electrode,
wherein the common electrode has a second cutout.

14. The liquid crystal display of claim 1, further comprising
a color filter disposed under the pixel electrode.

15. The liquid crystal display of claim 1, further comprising
an organic insulator disposed under the pixel electrode.

16. The liquid crystal display of claim 15, wherein
the thickness of the organic insulator is equal to or more than about 1 μm.

17. The liquid crystal display of claim 1, wherein
the first data line and the second data line respectively include a first portion disposed on a first straight line, a second portion disposed on a second straight line separated from the first straight line and substantially parallel to the first straight line, and a third portion connecting the first portion and the second portion,
and the second subpixel electrode overlaps the first portion of the first data line and the second portion of the second data line.
